(19) United States
(12) Patent Application Publication
(10) Pub. No.: US 2026/0048722 A1
(43) Pub. Date: Feb. 19, 2026

(54) HAPTIC FEEDBACK FOR TRAILER BRAKE CONTROL

(71) Applicant: Ford Global Technologies, LLC, Dearborn, MI (US)

(72) Inventors: Mijail Abel Avila Boza, Royal Oak, MI (US); Carina Avila Tapia, Mexico City (MX); Enrique Denicia Aguilar, Mexico City (MX); Shantal Leal Lombera, Mexico City (MX)

(73) Assignee: Ford Global Technologies, LLC, Dearborn, MI (US)

(21) Appl. No.: 18/804,479

(22) Filed: Aug. 14, 2024

(51) Int. Cl. B60T 7/08; B60T 7/10; G05G 5/03

(52) U.S. Cl. CPC B60T 7/085; B60T 7/10; G05G 5/03; B60T 2220/04; B60T 2250/04; G05G 2505/00

(57) ABSTRACT

A vehicle, includes a slider for controlling brakes of a towed vehicle operably coupled with the vehicle, an actuator configured to provide a target force to the slider, a first sensor that detects a position of the slider, and a second sensor for detecting a speed of the vehicle. A control circuitry is configured to determine the target force based on the position and the speed, determine a change in the position, and control the actuator to apply the target force in response to the change in the position.

### FIELD OF THE DISCLOSURE

The present disclosure generally relates to a trailer brake control unit and, more particularly, to haptic feedback control for a trailer brake control interface.

### BACKGROUND OF THE DISCLOSURE

Conventional interfaces for trailer brake controls can lack feedback, resulting in a less immersive user experience.

### SUMMARY OF THE DISCLOSURE

According to a first aspect of the present disclosure, a vehicle includes a slider for controlling brakes of a towed vehicle operably coupled with the vehicle, an actuator configured to provide a target force to the slider, a first sensor that detects a position of the slider, and a second sensor for detecting a speed of the vehicle. Control circuitry is configured to determine the target force based on the position and the speed, determine a change in the position, and control the actuator to apply the target force in response to the change in the position.

Embodiments of the first aspect of the present disclosure can include any one or a combination of the following features:
a gain input configured to control a proportion of braking of the vehicle to a braking signal to the towed vehicle coupled with the vehicle, wherein the control circuitry is configured to determine the target force based further on the proportion;
the control circuitry is configured to set the target force proportionally according to the speed, with a low speed corresponding to a low target force and with a high speed corresponding to a high target force;
the actuator includes a solenoid and power to the solenoid is controlled to adjust the target force;
the slider includes a knob translatable along a slide;
the target force is applied to the knob in response to a squeezing force applied to the knob;
the control circuitry is configured to control the actuator to apply the target force when the squeezing force is applied to bias against the squeezing force; and
the target force is determined via a function of a trailer brake gain, the speed of the vehicle, and a movement of the slider.

According to a second aspect of the present disclosure, a vehicle includes a slider for controlling brakes, an actuator configured to provide a target force to the slider, a first sensor that detects a position of the slider, and control circuitry configured to determine the target force based on the position and control the actuator to apply the target force.

Embodiments of the second aspect of the present disclosure can include any one or a combination of the following features:
the control circuitry is further configured to determine a change in the position and control the actuator to apply the target force in response to the change in the position;
a second sensor, wherein the control circuitry is configured to determine the speed of the vehicle based on the second sensor, wherein determination of the target force is based on the speed of the vehicle;
the control circuitry is configured to set the target force proportionally according to the speed, with a low speed corresponding to a low target force and with a high speed corresponding to a high target force;
the actuator includes a solenoid and power to the solenoid is controlled to adjust the target force;
the slider includes a knob translatable along a slide, wherein the target force is applied to the knob in response to a squeezing force applied to the knob;
the control circuitry is configured to control the actuator to apply the target force when the squeezing force is applied to bias against the squeezing force;
the vehicle further includes a gain input that provides a proportion of braking of the vehicle to a braking signal to a towed vehicle coupled with the vehicle, wherein the control circuitry is configured to determine the target force based further on the proportion; and
the target force is determined via a function of a trailer brake gain, a speed of the vehicle, and a movement of the slider.

According to a third aspect of the present disclosure, a vehicle includes a slider for controlling brakes of a towed vehicle operably coupled with the vehicle, an actuator configured to provide a target force to the slider, a first sensor that detects a position of the slider, a second sensor for detecting a speed of the vehicle, a gain input that provides a proportion of braking of the vehicle to a braking signal to the towed vehicle, and control circuitry configured to determine the target force based on the speed and the proportion, determine a change in the position, and control the actuator to apply the target force in response to the change in the position.

Embodiments of the second aspect of the present disclosure can include any one or a combination of the following features:
the slider includes a knob translatable along a slide, wherein the target force is applied to the knob in response to a squeezing force applied to the knob;
the control circuitry is configured to control the actuator to apply the target force when the squeezing force is applied to bias against the squeezing force.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a towing connection for a vehicle incorporating a towing brake control system according to one aspect of the present disclosure;

FIG. 2 is a schematic view of a towing brake control system according to one aspect of the present disclosure;

FIG. 3 is a schematic diagram of a trailer brake control system constructed according to one aspect of the present disclosure; and

FIG. 4 is a force diagram of a portion of a user interface of a trailer brake control unit constructed according to one aspect of the present disclosure.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

The present illustrated embodiments reside primarily in combinations of method steps and apparatus components related to haptic feedback for trailer brake control. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises. a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about. ” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

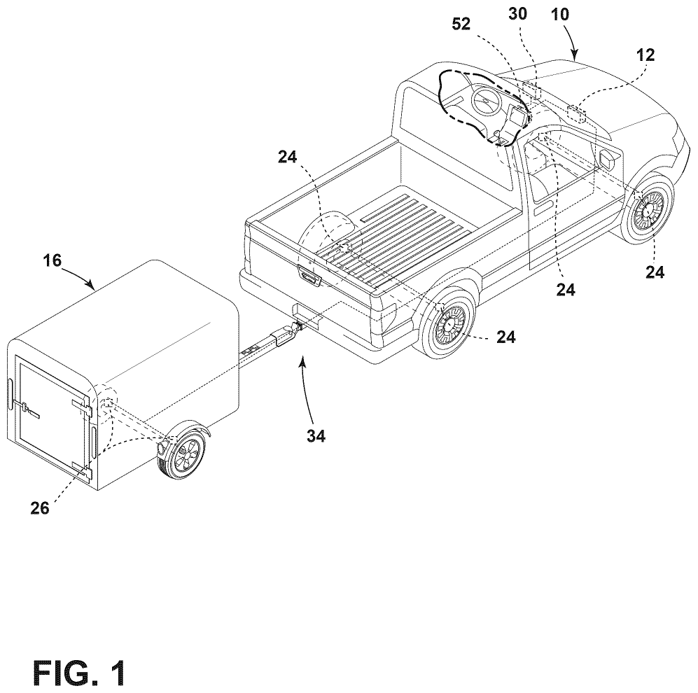

Referring generally to FIGS. 1-4, the present systems and methods can provide for a vehicle 10 that incorporates active feedback for manual braking using a trailer brake control unit 12. The trailer brake control unit 12 can incorporate a sliding mechanism that can have a varying resistance force that applies when a user adjusts the sliding mechanism. The present systems and methods can provide for dynamic and enhanced feedback via the feedback force that can be based on various operating parameters of the vehicle 10, a position of the sliding mechanism, and/or a gain value. In effect, the systems and methods described herein can simulate indications of braking commands to a towed device that can be based on kinematics of the vehicle 10.

With continued reference to FIGS. 1-4, a vehicle 10 includes a slider 14 for controlling brakes of a towed vehicle 16 operably coupled with the vehicle 10. The vehicle 10 includes an actuator 18 configured to provide a target force to the slider 14, a first sensor 20 that detects a position of the slider 14, and a second sensor 22 for detecting a speed of the vehicle 10. Control circuitry is configured to determine the target force based on the position and the speed, determine a change in the position, and control the actuator 18 to apply the target force in response to the change in the position.

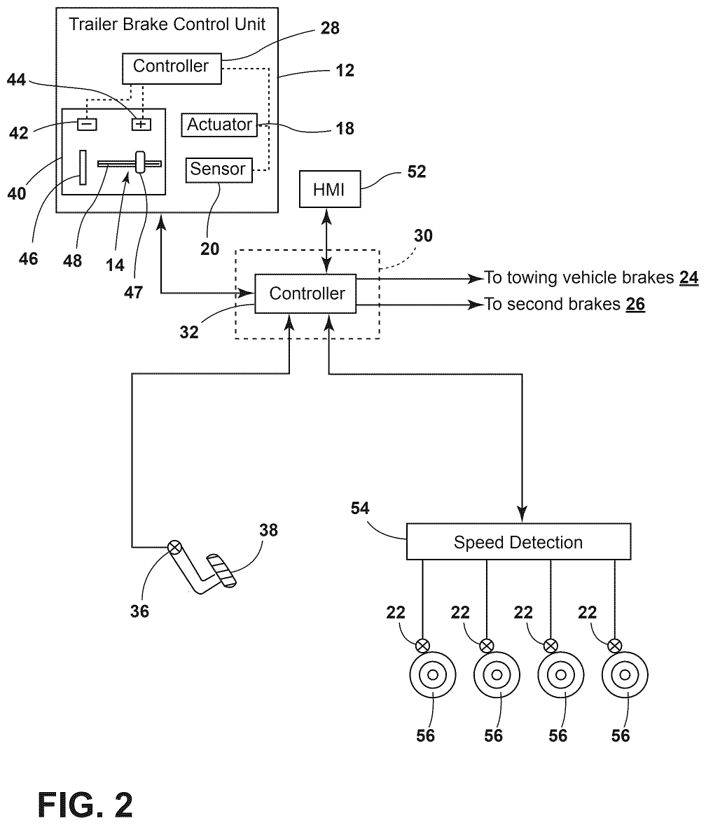

Referring now to FIG. 1, the vehicle 10 can include any automotive or nonautomotive vehicle 10, such as a truck. The vehicle 10, or towing vehicle 10, can be configured to tow a towed vehicle 16, such as a trailer. The vehicle 10 can include first brakes 24 and the towing vehicle 10 can include second brakes 26. Each of the first brakes 24 and second brakes 26 can be controlled by the control circuitry. For example, the control circuitry can include a trailer brake control unit 12 having a trailer brake controller 28 and/or a primary brake control unit 30 having a primary brake controller 32 (FIG. 2). The trailer brake control unit 12 to be in communication with the primary brake control unit 30. In general, the control circuitry can receive braking signals indicative of inputs by a user, process the braking signals to generate a braking command, and communicate the braking command to the first brakes 24 and/or the second brakes 26. In some examples, the primary control unit includes an antilock braking system (ABS) controller or may be in communication with the ABS controller. In some examples, signals communicated from the trailer brake controller 28 do not pass through the primary brake control unit 30, but are rather communicated directly to the towed vehicle 16.

Electrical signals from the control circuitry can be communicated to the second brakes 26 when the towed vehicle 16 is electrically connected with the towing vehicle 10. For example, an electrical interface can be provided at a rear 34 of the towing vehicle 10 for receiving a plug or otherwise electrically connecting the second brakes 26 of the towed vehicle 16 with circuitry of the towing vehicle 10. It is contemplated that the second brakes 26 can be electric, electric-over hydraulic (EOH), or any other brake actuatable in response to electrical signals. In general, a purpose of the trailer brake control unit 12 is to set a gain, or proportion, of brake force applied by the second brakes 26 relative to the first brakes 24. The trailer brake controller 28 can also provide for manual braking during operation of the vehicle 10. It is further contemplated that, while demonstrated as a trailer, the towed vehicle 16 may embody any other device that can be pulled or otherwise moved by physical and electrical connection with the towing vehicle 10.

Referring now to FIG. 2, the primary brake controller 32 can be configured to communicate braking signals to the first brakes 24 and to the second brakes 26 based on signals received from various input devices. For example, the primary brake controller 32 can be in electrical communication with a brake input sensor 36 that is operably coupled with a brake pedal 38 of the towing vehicle 10. For example, the brake input sensor 36 can include an angular sensor, a potentiometer, a position sensor, a capacitive sensor, an encoder, or any electrical detector that can communicate a position of the brake pedal 38 and/or other quality of the brake pedal 38 indicative of a braking procedure to the primary brake controller 32. The trailer brake controller 28 can be configured to communicate and receive signals to/from the primary brake controller 32 related to control of the second brakes 26. For example, the gain can be communicated to the primary brake controller 32, a manual brake command can be communicated to the primary brake controller 32, etc.

The trailer brake control unit 12 can include a user interface 40 that includes gain control buttons 42, 44, a slider 14 for controlling manual braking of the secondary brakes, and a reference knob 46 adjacent to the slider 14 and generally aligned with the slider 14. The slider 14 includes a control knob 47 coupled to a slide 48 that allows translational motion of the control knob 47 along the slide 48. The reference knob 46 can be fixedly mounted at the user interface 40, whereas the control knob 47 can be movable along the slide 48. Accordingly, the user interface 40 may be configured such that a user can apply a force to squeeze the reference knob 46 and the control knob 47 together, thereby resulting in the control knob 47 being moved toward the stationary reference knob 46. Manual braking of the second brakes 26 can be determined by a distance between the reference knob 46 and the control knob 47 and, more particularly, a position of the control knob 47 on the slide 48. For example, the control knob 47 positioned closer to one end of the slide 48 can correspond to a first brake force relative to a brake force generated when the control knob 47 is at another end of the slide 48. The user interface 40 further includes gain control buttons 42, 44, such as a decrement button 42 and an increment button 44. The buttons 42, 44 can be in communication with the trailer brake controller 28 and be operable to set the gain, or proportion, of braking to be applied to the second brakes 26 relative to the force applied to the first brakes 24 when a braking command from the brake pedal 38 is commenced. It is contemplated that the braking command generated based on the brake pedal 38 can, in some examples, be based on an autonomous driving mode, such that the braking command for the towing vehicle 10 can originate from another source other than the brake pedal 38 (e.g., an autonomous control system). In either example, the trailer brake controller 28 can control a proportion of the braking force as applied to the second brakes 26 relative to the first brakes 24.

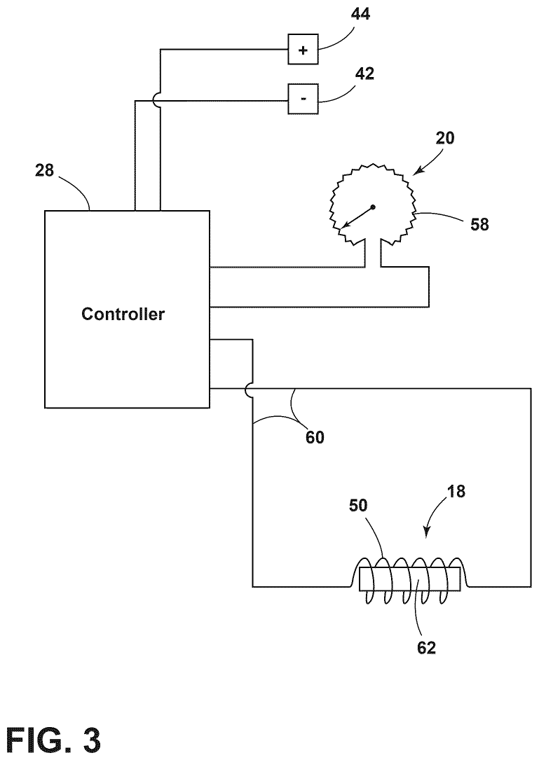

The trailer brake controller 28 can also include an actuator 18 for controlling haptic feedback to the user via the control knob 47 and a first sensor 20 for detecting a position of the control knob 47. The first sensor 20 can be any sensor that can detect a position of the control knob 47 including, for example, a potentiometer 58, an inductive sensor, a capacitive sensor, an encoder, or any other type of detector that can communicate or relay a signal indicative of a position of the control knob 47. The actuator 18 can include any electromechanical actuator 18, such as a motor, a servo, a solenoid, a valve, or any other electromechanical device that can control a force applied to the control knob 47. As will be described in reference to FIG. 3, the actuator 18 can include a solenoid 50 that receives electrical power from the trailer brake controller 28 and, based on the power level, controls the force applied to the control knob 47 when the control knob 47 is engaged by the user.

With continued reference to FIG. 2, a human-machine interface (HMI 52) may be in communication with the primary brake controller 32 and may be operable to control various functions related to trailer brake control, such as the gain. For example, the HMI 52 can include a touchscreen, such that, when a user selects any of the digital objects are the digital object, the HMI 52 communicates an indication that trailer brake control functionality has been adjusted. Accordingly, the primary brake controller 32 can communicate to the trailer brake control unit 12 the gain as set by the HMI 52. In this way, the primary brake controller 32 and trailer brake controller 28 can maintain a consistent gain reading/target value, such that either or both of the trailer brake control unit 12 and the HMI 52 can be used to control the trailer brake gain.

The primary brake controller 32 can also be in communication with other systems of the towing vehicle 10, such as the powertrain, lighting, or any other system of the vehicle 10. In the present example, the controller 32 is in communication with a speed detection unit 54 which can include one or more of the second sensors 22 for detecting the speed of the vehicle 10. In the present example of the second sensors 22 are wheel speed sensors, though any type of sensor that can provide data for speed detection used can be provided. For example, the second sensors 22 can be position sensors, or encoders, that track a position of wheels 56 of the towed vehicle 16, and the primary brake controller 32 (or the speed detection unit 54) can be configured to determine a rate of change of the positions of the wheels 56 to determine the rotational speed of the wheels 56 and, therefore, the speed of the vehicle 10. It is contemplated that other speed detection sensors can be provided, such as cameras, accelerometers, gyroscopes, position sensors, speed sensors, or any combination thereof.

In general, the control circuitry (e.g., the trailer brake control unit 12 and/or the primary brake controller) can utilize the speed of the vehicle 10, the position of the control knob 47, and/or the gain to determine a target force to be applied to the slider 14. For example, at high speeds, movement of the control knob 47 toward a reference point, such as the reference knob 46, can require more force than at low speeds of the vehicle 10. In some examples, when the control knob 47 is positioned nearer to the reference knob 46 than is depicted in FIG. 2, the target force can be determined higher than as shown in the position as depicted in FIG. 2. In general, the target force can be set to indicate to the user the effect of the manual brake operation being performed, which can be a function of the speed of the vehicle 10, the gain, and the position or movement of the control knob 47.

It is contemplated related that, while shown and described herein as movement of the control knob 47 to the left being an increase in a manual braking operation for the second brakes 26, the slider 14 may be oriented in another manner, such as with movement of the control knob 47 to the right corresponding to an increase in brake force. Thus, while described as a squeezing force to brake between the reference knob 46 and the control knob 47 to initiate a manual brake command, in some examples, the control about knob can be moved away from the reference knob 46 to increase braking command.

The trailer brake controller 28 and the primary brake controller 32 can each include a processor and a memory storing instructions that, when executed by the processer, cause the control circuitry to perform various operations related to trailer braking. For example, the trailer brake controller 28 can store instructions for causing activation of the actuator 18 and/or reading of the data from the first sensor 20, the second sensor 22, and/or the primary brake controller 32. The position of the control knob 47 can also be processed to determine manual activation of the second brakes 26. The processor of the primary brake controller 32 can cause data to be ready from or communicated to the HMI 52, the trailer brake controller 28, the speed detection unit, and the first and second brakes 26. In general, the trailer brake controller 28 and the primary brake controller 32 can operate together or apart to perform the steps of the control circuitry in some examples.

Referring now to FIG. 3, an exemplary implementation of the trailer brake control unit 12 is demonstrated with exemplary electrical devices. In this example, the position sensor includes a potentiometer 58, such that movement of the control knob 47 along the slide 48 results in a change in resistance which can be measured by the trailer brake controller 28. For example, a constant voltage could be applied across the potentiometer 58 and the controller 28 may read a current, or vice versa. The actuator 18 in the present example is demonstrated as a solenoid 50 having conductors 60 for applying a voltage, such as a direct current (DC) voltage and/or an alternating current (AC) voltage, across an armature 62 to move the armature 62 a distance proportional to the power applied to the conductors 60. In this example, the solenoid 50 is used to apply the target force which can be based on any of the parameters previously described. Accordingly, the target force can be a function of a target voltage, current, or the like, applied to the solenoid 50. It is contemplated that this example is demonstrated in FIG. 3 is merely exemplary and alternative or additional actuators 18 and sensors can be utilized. For example, the haptic feedback can be provided via a servo motor that can communicate both position and apply force. It is further contemplated that, in some examples, the trailer brake controller 28 can read feedback from the solenoid 50 that can be indicative of the user manually adjusting the control knob 47 (e.g., manual movement of the armature 62) changing an amount of power at the solenoid 50.

Also demonstrated in FIG. 3 are the gain buttons such as the increment button 44 and the decrement button 42. In some examples, the increment and decrement buttons 42, 44 can communicate pulses each time a user presses and releases the corresponding buttons 42, 44. A counter can be stored in either controller 28, 32 for tracking the gain level. In some examples, the gain can be a value between zero and 10. In other examples, the gain is stored as a real value.

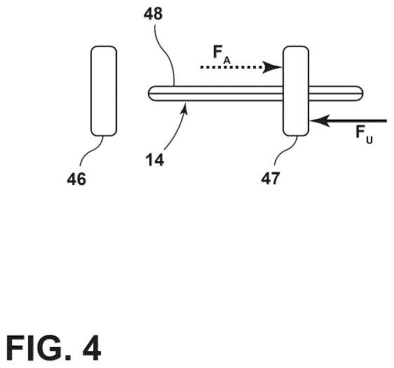

Referring now to FIG. 4, a force diagram indicating a user force Fu applied to the control knob 47 and an actuator force FA as applied against the control knob 47. In this example, the actuator force FA is shown in a dashed arrow to indicate that the actuator force FA is reactive to the user force Fu. For example, and with brief reference back to FIG. 3, the target force can be configured by the controller to be applied in response to receiving the user force Fu. For example, the target force can be determined prior to engagement of the control knob 47 by the user and applied once the user squeezes the control knob 47 relative to the reference knob 46. As previously described, trailer brake controller 28 can be in communication with the primary brake controller 32, such that, in response to both a manual brake operation at the brake pedal 38 and manual control of the trailer brake controller 28, the haptic feedback provided by the actuator 18 can be highly reactive and dynamic based on the various parameters previously described (e.g., speed, position of the control knob 47, gain). It is contemplated that the speed, gain, position, and/or travel/movement of the control knob 47 can be weighted in a function stored in the trailer brake controller 28, and the weights of each variable can be adjusted to tune the response of the trailer brake controller 28.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle, comprising:
a slider for controlling brakes of a towed vehicle operably coupled with the vehicle;
an actuator configured to provide a target force to the slider;
a first sensor that detects a position of the slider;
a second sensor for detecting a speed of the vehicle;
control circuitry configured to:
determine the target force based on the position and the speed;
determine a change in the position; and
control the actuator to apply the target force in response to the change in the position.

2. The vehicle of claim 1, further comprising:
a gain input configured to control a proportion of braking of the vehicle to a braking signal to the towed vehicle coupled with the vehicle, wherein the control circuitry is configured to determine the target force based further on the proportion.

3. The vehicle of claim 1, wherein the control circuitry is configured to set the target force proportionally according to the speed, with a low speed corresponding to a low target force and with a high speed corresponding to a high target force.

4. The vehicle of claim 1, wherein the actuator includes a solenoid and power to the solenoid is controlled to adjust the target force.

5. The vehicle of claim 1, wherein the slider includes a knob translatable along a slide.

6. The vehicle of claim 5, wherein the target force is applied to the knob in response to a squeezing force applied to the knob.

7. The vehicle of claim 5, wherein the control circuitry is configured to control the actuator to apply the target force when the squeezing force is applied to bias against the squeezing force.

8. The vehicle of claim 1, wherein the target force is determined via a function of a trailer brake gain, the speed of the vehicle, and a movement of the slider.

9. A vehicle, comprising:
a slider for controlling brakes;
an actuator configured to provide a target force to the slider;
a first sensor that detects a position of the slider;
control circuitry configured to determine the target force based on the position and control the actuator to apply the target force.

10. The vehicle of claim 9, wherein the control circuitry is further configured to determine a change in the position and control the actuator to apply the target force in response to the change in the position.

11. The vehicle of claim 9, further comprising:
a second sensor, wherein the control circuitry is configured to determine the speed of the vehicle based on the second sensor, wherein determination of the target force is based on the speed of the vehicle.

12. The vehicle of claim 11, wherein the control circuitry is configured to set the target force proportionally according to the speed, with a low speed corresponding to a low target force and with a high speed corresponding to a high target force.

13. The vehicle of claim 12, wherein the actuator includes a solenoid and power to the solenoid is controlled to adjust the target force.

14. The vehicle of claim 9, wherein the slider includes a knob translatable along a slide, wherein the target force is applied to the knob in response to a squeezing force applied to the knob.

15. The vehicle of claim 14, wherein the control circuitry is configured to control the actuator to apply the target force when the squeezing force is applied to bias against the squeezing force.

16. The vehicle of claim 9, further comprising:
a gain input that provides a proportion of braking of the vehicle to a braking signal to a towed vehicle coupled with the vehicle, wherein the control circuitry is configured to determine the target force based further on the proportion.

17. The vehicle of claim 9, wherein the target force is determined via a function of a trailer brake gain, a speed of the vehicle, and a movement of the slider.

18. A vehicle, comprising:
a slider for controlling brakes of a towed vehicle operably coupled with the vehicle;
an actuator configured to provide a target force to the slider;
a first sensor that detects a position of the slider;
a second sensor for detecting a speed of the vehicle;
a gain input that provides a proportion of braking of the vehicle to a braking signal to the towed vehicle; and
control circuitry configured to:
determine the target force based on the speed and the proportion;
determine a change in the position; and
control the actuator to apply the target force in response to the change in the position.

19. The vehicle of claim 18, wherein the slider includes a knob translatable along a slide, wherein the target force is applied to the knob in response to a squeezing force applied to the knob.

20. The vehicle of claim 19, wherein the control circuitry is configured to control the actuator to apply the target force when the squeezing force is applied to bias against the squeezing force.
